(19) United States
(12) Patent Application Publication
(10) Pub. No.: US 2013/0111025 A1
(43) Pub. Date: May 2, 2013

(54) CLIENT APPLICATION AND RESOURCE ARBITRATION

(71) Applicants: Sriram Sampathkumaran, San Diego, CA (US); Helmut Neumann, Urbandale, IA (US); Eric Yam, San Diego, CA (US)

(72) Inventors: Sriram Sampathkumaran, San Diego, CA (US); Helmut Neumann, Urbandale, IA (US); Eric Yam, San Diego, CA (US)

(73) Assignee: SONY CORPORATION, A JAPANESE CORPORATION, Tokyo (JP)

(21) Appl. No.: 13/285,121

(22) Filed: Oct. 31, 2011

(51) Int. Cl. G06F 15/173

(52) U.S. Cl. 709/225

(57) ABSTRACT

A method and apparatus is provided for arbitrating client application access to at least one resource by determining two or more client applications of a plurality of client applications to grant simultaneous access to the at least one resource. By this, data and resources are exposed to multiple client applications and simultaneous multiple use of resources by separate multiple client applications can be achieved.

### BACKGROUND OF THE INVENTION

1. Field of the Invention

The present invention relates generally to arbitration of resources, and more specifically to arbitration of access to one or more resources by multiple client applications.

2. Discussion of the Related Art

Clients, such as client applications, often require resources of a server or system to complete a given task. These client applications may represent any number of given software or hardware clients designed to interface with the server system either on the same or separate processing platforms. The resources may represent any such resource as may be required by the clients to complete a task, and may represent hardware resources and/or one or more engines designed to interface with the hardware resource. The advent of certain new client applications has driven a need for multiple client applications to request the usage of a resource simultaneously. Similarly, a need is developing for resource to provide data or messages to multiple client applications that would benefit from simultaneous receipt.

Traditionally, arbitration of these multiple requests from multiple client applications, or data or messages from resources, has been limited to a one-to-one relationship. By this, at any given time, only one client can access each resource. Additionally, at any given time, a message or data from a resource is only sent to the one client application with access to that resource. When multiple clients request access to the same resource, access is granted to one of the client applications based on a set of arbitration rules or priorities. Later request for access to a resource already in use by a different client can be denied because the resource is currently in use, or the request can be granted (i.e., if it has a higher priority) resulting in the other client's loss of access in exchange for the new client application. Any number of rules can and do exist for access to resources by clients. However, as previously mentioned, traditional arbitration utilizing these rules is limited to one-to-one relationships between clients and resources.

### SUMMARY OF THE INVENTION

Several embodiments of the invention advantageously address the needs above as well as other needs by providing a method of arbitrating client application access to at least one resource, the method further comprising: receiving at a computing device at least one message from at least one resource; determining by the computing device two or more client applications of a plurality of client applications to grant simultaneous access to the at least one message based on the at least one message and a plurality of arbitration rules; granting, in response to the determining, by the computing device simultaneous access to the at least one message to the two or more client applications; and denying, in response to the determining, by the computing device access to the at least one message to at least one other client application of the plurality of client applications.

In another embodiment, the invention can be characterized as a providing a method of arbitrating client application requests for access to at least one resource comprising: receiving at a computing device a first request to access at least one resource from a first client application of a plurality of client applications; granting by the computing device the first request to access the at least one resource by communicating the first request to the at least one resource; receiving by the computing device a second request to access the at least one resource from a second client application of the plurality of client applications; determining by the computing device to grant access to the at least one resource to the second client application based on the second request and a plurality of arbitration rules; notifying the first client application of the first client application's temporary loss of focus with respect to the at least one resource in response to receiving the second request; and granting the second request to access the at least one resource by communicating the second request to the at least one resource.

In a further embodiment, the invention may be characterized as an apparatus for arbitrating client application access to at least one resource comprising: an Application Programming Interface (API) module configured to communicate with a plurality of client applications; and an arbitration module communicatively connected to the API module, wherein the arbitration module is configured to: receive at least one message from at least one resource; determine two or more client applications of the plurality of client applications to communicate the at least one message to based on the at least one message and a plurality of arbitration rules; communicate the at least one message to the two or more client applications, wherein the arbitration module is further configured to communicate the at least one message to at least one client application of the two or more client applications of the plurality of client applications through the API module; and deny access to the at least one message to at least one other client application of the plurality of client applications.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is an apparatus for arbitrating client application access to at least one resource in accordance with at least one embodiment.

FIG. 2 is a more detailed depiction of the apparatus illustrated in FIG. 1.

FIG. 3 is an alternate embodiment of the apparatus configuration depicted in FIG. 2.

FIG. 4 is a non-limiting contextual example of the operation of various embodiments of the apparatus as depicted in FIGS. 1-3,

FIG. 5 is another non-limiting contextual example of the operation of various embodiments of the apparatus as depicted in FIGS. 1-3.

FIG. 6 is a flow diagram illustrating a method of arbitrating client application access to at least one resource in accordance with various embodiments.

FIG. 7 is a flow diagram depicting another embodiment of the method illustrated in FIG. 6.

FIG. 8 is a flow diagram illustrating a method of arbitrating client application requests for access to at least one resource in accordance with various embodiments.

FIG. 9 is a flow diagram depicting further steps from those illustrated in FIG. 8 in accordance with one embodiment.

FIG. 10 is another flow diagram depicting further steps from those illustrated in FIG. 8 in accordance with another embodiment.

FIG. 11 is yet another flow diagram depicting further steps from those illustrated in FIG. 8 in accordance with another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

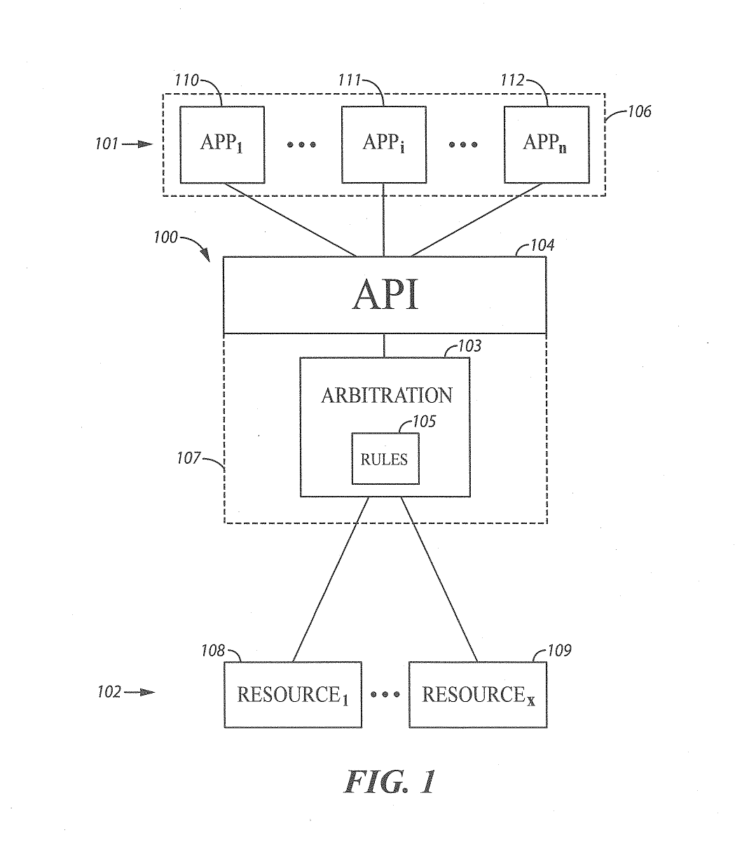

Referring first to FIG. 1, an apparatus 100 for arbitrating client application 101 access to at least one resource 102 in accordance with at least one embodiment is illustrated. The apparatus 100 comprises at least an arbitration module 103 and an application programming interface module (API) 104. The arbitration module 103 may further comprise a collection of arbitration rules 105. Alternatively, the arbitration rules 105 may exist in a separate module or apparatus (not shown) that allows for reference by the arbitration module 103.

The API 104 is configured to communicate with a plurality of client applications 101. The API 104 represents a particular set of rules and specifications that the client applications 101 can follow to communicate with the apparatus 100, the underlying system or framework 210, and/or the plurality of resources 102. As is generally understood in the art, application programming interfaces, such as the API 104, may operate to define one or more resource request conventions, vocabularies, behaviors, functions, protocols, or libraries. The API 104 may establish various functions or routines which client applications 101 may call to produce a result or retrieve information. The API 104 may be language-dependent or language-independent, so that it can be called from client applications 101 written in different programming languages, and, in some embodiments, may comprise an object-oriented API. The API 104 advantageously allows for changes to be made in underlying programming or engines (203, 204, 205 described below) while maintaining a single cohesive interface for the client applications 101. The term “Application Programming Interface” or “API” as used herein may refer to a complete interface, a single function, or even a set of APIs.

The arbitration module 103 may comprise a computing device as are known in the art, possibly further comprising one or more processing devices, memory devices, inputs, outputs, or other known hardware modules. The API 104 may comprise a similar or dissimilar computing device as the arbitration module 103. Further, by some approaches, the arbitration and API 104 may comprise a shared computing device. Various resources 102 and client applications 101 may also exist on computing devices, whether they be other computing devices or the same computing device on which one of the arbitration module 103 or the API 104, or both, may exist.

Communications between the API 104 and the plurality of client applications 101 may be effectuated locally (such as on the same processor, processing platform, multi-core processor, computing device, controller, microcontroller, etc.) or via one or more networks. Networks, as are known in the art, may effectuate communication utilizing various connectivity technologies and protocols such as GSM/EDGE, IDEN, CDMA, EV-DO, UMTS, Bluetooth, Wi-Fi, LTE, Near Field Communication (NFC), WiMAX, Secure Socket Layer (SSL), Hypertext Transfer Protocol (HTTP), Simple Mail Transfer Protocol (SMTP), Domain Name System (DNS), and other connectivity technologies and protocols as are known in the art. By one approach, a client-server relationship may be established between the plurality of client applications 101 and the apparatus 100.

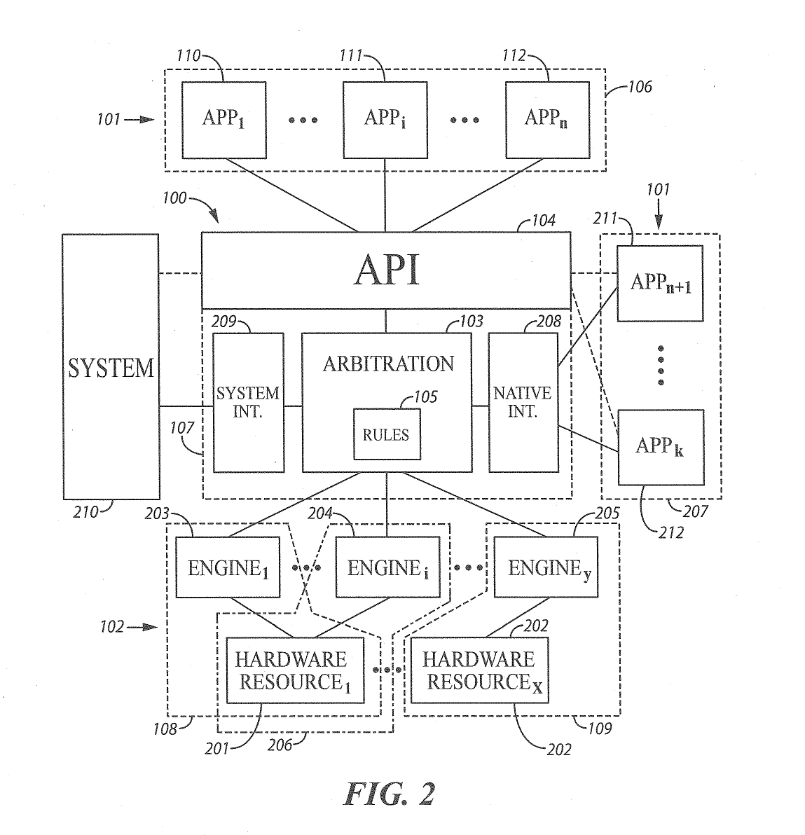

The plurality of client applications 101 may exist in an application layer 106. These client applications 101 may comprise, for example, Android or Apple applications. Android applications are usually developed in the Java programming language using the Android Software Development Kit, though other development tools are commonly used. Apple applications are usually developed using the iOS SDK (Software Development Kit) or iPhone SDK. Other styles and formats of client applications 101 as are known in the art may exist and may, by some embodiments, be compatible with the apparatus 100. Additionally, and with brief reference to FIG. 2, a portion of the plurality of applications 101, as shown by APPₙ₊₁ 211 to APPₖ 212 may exist in a native layer 207.

The arbitration module 103 is communicatively connected to the API 104, enabling communication between the arbitration module 103 and the plurality of client applications 101 located in the application layer 106 via the API 104. By some embodiments, the API 104 and the arbitration module 103 together comprise the apparatus 100. They may co-exist as an indistinguishable single module (as indicated by the dashed line 107) or as distinguishable modules 103, 104 within the apparatus 100. Further, in one approach, the API 104 and the arbitration module 103 may further be incorporated into the system or framework 210 as a whole.

The arbitration module 103 is also communicatively connected to a plurality of resources 102. This connection may be direct, or in other embodiments, through various other layers or modules (not shown), such as an operating system (OS) or portions of an OS, various kernels, daemons, or native layer modules. Example operating systems include Android, Apple iOS, Mac OS, Windows, Windows Mobile, Windows Phone, BlackBerry OS, Linux, Unix, HP webOS, Samsung Bada, Nokia MeeGo, Maemo, Symbian OS, Brew, LiMo, and other known mobile operating systems. Kernels may comprise monolithic kernels, microkernels, hybrid or modular kernels, exokernels, and nanokernels. Examples of kernels are Linux, Unix, or other known kernels as are part of or included with various operating systems (described above). The apparatus 100, including the arbitration module 103 and the API 104, may be further incorporated into one or more operating systems. For example, the API 104 may comprise an original or modified Android or Apple iOS API, thus effectuating compatibility with Android or Apple compatible client applications.

With brief reference again to FIG. 2, in some embodiments, the plurality of resources 102 may further comprise at least one hardware resource 201, 202 and at least one engine 203, 204, 205. For example, Resource₁ 108 (as shown in FIG. 1) may further comprise Engine₁ 203 and Hardware Resource₁ 201. Resourceₓ 109 (as shown in FIG. 1) may further comprise Engine_{y} 205 and Hardware Resourceₓ 202. An additional resource 206 not shown in FIG. 1 may comprise Engineᵢ 204 and Hardware Resource₁ 201. Multiple engines 203, 204, 205 may share individual or multiple hardware resources 201, 202, such as is shown by Engine₁ 203 and Engineᵢ 204 both in communication with Hardware Resource₁ 201. Additionally, engines 203, 204, 205 may access more than one hardware resource 201, 202. Generally, and in accordance with many embodiments, an engine 203, 204, 205 is an encapsulated block of functionality that drives the operation of a program or function. Engines 203, 204, 205 may be written and operated in Linux, though other languages and operating systems may be utilized to facilitate their functionality. Usually the engine 203, 204, 205 operates by receiving an input, processing the input, and providing an output where the output is often of a different order than the input. As a non-limiting example, a face detection engine (represented in this example by RESOURCE₁ 108) may be in communication with one or more cameras 402. The face detection engine 203 will receive images from the camera 402 as an input, process those images, and output the presence of faces and/or the identification of faces it is trained to recognize. Such an output would often be more useable by client applications 101 than the raw image input from the camera 402. These outputs from the engines 203, 204, 205 are then transmitted directly or indirectly to the arbitration module 103 for eventual delivery to one or more client applications 101.

Resources 102, and more specifically in some embodiments, hardware resources 201, 202, may comprise, for example, video cameras, still cameras, microphones, speakers, touchscreens, keypads, input sensors, network connectivity components, GPS, accelerometers, gyroscopes, magnetometers, dedicated gaming controls, proximity and pressure sensors, thermometers, accelerated 2D bit blits (with hardware orientation, scaling, pixel format conversion) and accelerated 3D graphics. Many other examples of resources 102 and hardware resources 201, 202 exist and are known in the art, which are capable of being utilized by many of the embodiments described herein.

By at least one approach, and as described in portions above and below, a service-based architecture (or service-oriented architecture) may be created allowing for arbitration of simultaneous access by multiple client application to one or more resources.

Continuing with FIG. 2, a more detailed depiction of the apparatus 100 illustrated in FIG. 1 is shown. As with

FIG. 1, the apparatus 100 is shown including the API 104 and the arbitration module 103 optionally housing the arbitration rules 105. A plurality of client applications 101 is shown, existing in either the application layer 106 or the native layer 207. As described above, a plurality of resources 102 are shown, each resource 102 optionally comprising at least one engine 203, 204, 205 and at least one hardware resource 201, 202. Additionally, the apparatus 100 may comprise a native interface module 208 and a system interface module 209.

The system interface module 209 is communicatively connected to the arbitration module 103 and is configured to send or receive at least one system event from the system or framework 210. System events may comprise any number of messages from the system 210, including but limited in no way to power on or power off events, sleep mode events, phone call events, intents, etc. By one approach, the system 210 may exist as a separate entity from the apparatus 100 as depicted in FIG. 2. By another approach, the apparatus 100, including the API 104 and the arbitration module 103, may exist within and as part of the system 210. Additionally, by another approach, the plurality of client applications 101 and resources 102 may also exist within the same system 210. As such, and by this approach, the previously described relationship between the plurality of client applications 101 and the apparatus 100 and/or system 210 may exist within a single system 210, possibly comprising a single computing or processing device (much as modern smartphones, tablet computers, and smart appliances, etc., may operate). Android OS and Apple iOS, amongst other operating systems, provide for both single and multi system or processor arrangements, as is understood in the art.

The native interface module 208 is communicatively connected to the arbitration module 103 and is further configured to communicate with at least one client application 211, 212 located in the native layer 207. By this, native layer client applications 211, 212 are able to communicate with the arbitration module 103 without the necessity of communication through the API 104. Accordingly, the arbitration module 103 is capable of arbitrating access to resources 102 between multiple client applications 101 whether they exist in the application layer 106 or the native layer 207.

By another approach, the client applications 101 existing in the native layer 207 (211, 212) may optionally communicate through the API 104 as do other client applications 101. Additionally, the system 210 may communicate system events to the API 104 instead of to the system interface module 209. As such, a distinction in the way the system 210 or each client application 101 (whether in the application layer 106 or the native layer 207) communicates with the apparatus 100 may be eliminated.

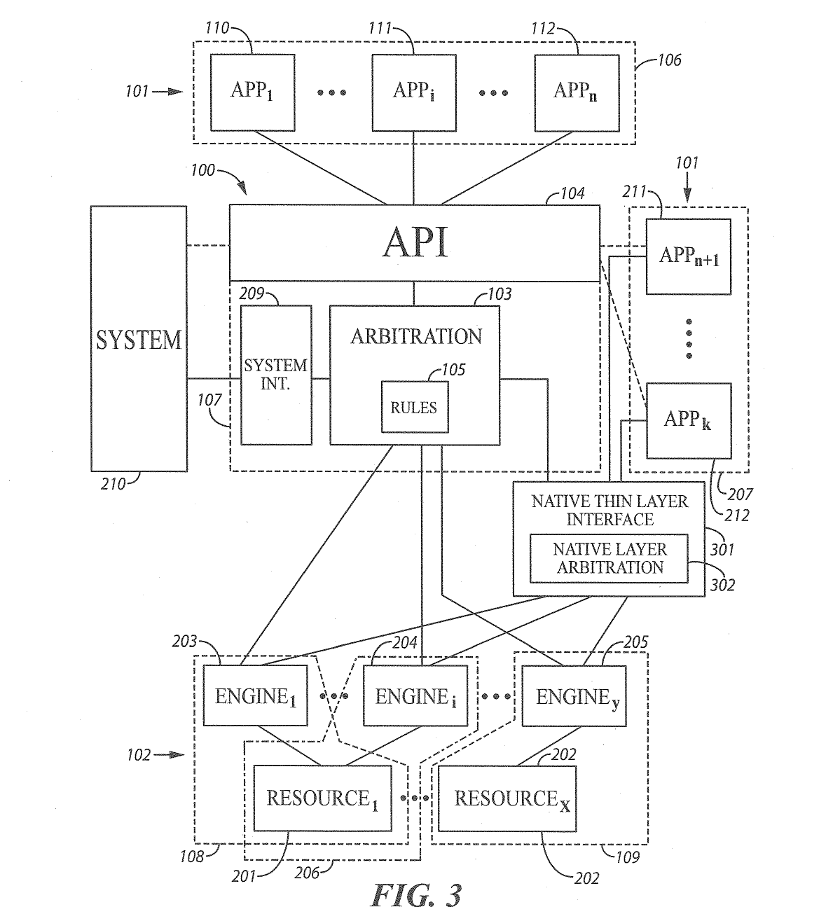

With reference now to FIG. 3, an alternate embodiment of the apparatus 100 configuration depicted in FIG. 2 is shown. FIG. 3 is much like FIG. 2, with the exception that a native thin layer interface 301 is provided. By one approach, the native thin layer interface 301 may exist external to the apparatus 100 comprising the API 104 and the arbitration module 103. By a different approach, it may exist as part of the apparatus 100. In some embodiments, the native thin layer interface 301 will comprise a native layer arbitration module 302 that is communicatively connected to the arbitration module 103 of the apparatus 100 and is configured to communicate with client applications 101 in the native layer 207 (i.e., client applications 211, 212). The native layer arbitration module 302 is further configured to communicate with the arbitration module 103 to effectuate proper arbitration of the client application 211, 212 requests and access in the native layer 207. As described before, the arbitration module 103 of the apparatus 100 is configured to communicate with the client applications 101 of the application layer 106 (i.e., client applications 110, 111, 112) through the API 104. Together, the native layer arbitration module 302 and the arbitration module 103 arbitrate access to resources 102 by the client applications 101 existing in the application layer 106 and in the native layer 207.

Additionally, and by at least one embodiment, the native thin layer interface 301 is configured to communicate with the plurality of resources 102. So configured, communications between the client applications 211, 212 in the native layer 207 and the resources 102 are effectuated through the native thin layer interface 301 rather than through the arbitration module 103 or the API 104 of the apparatus 100.

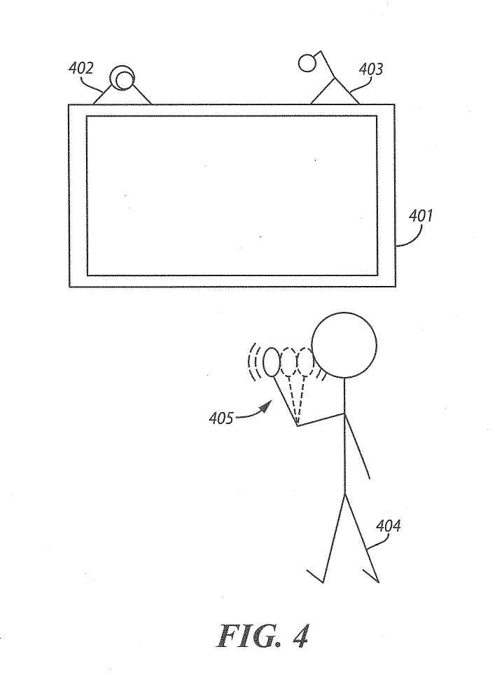

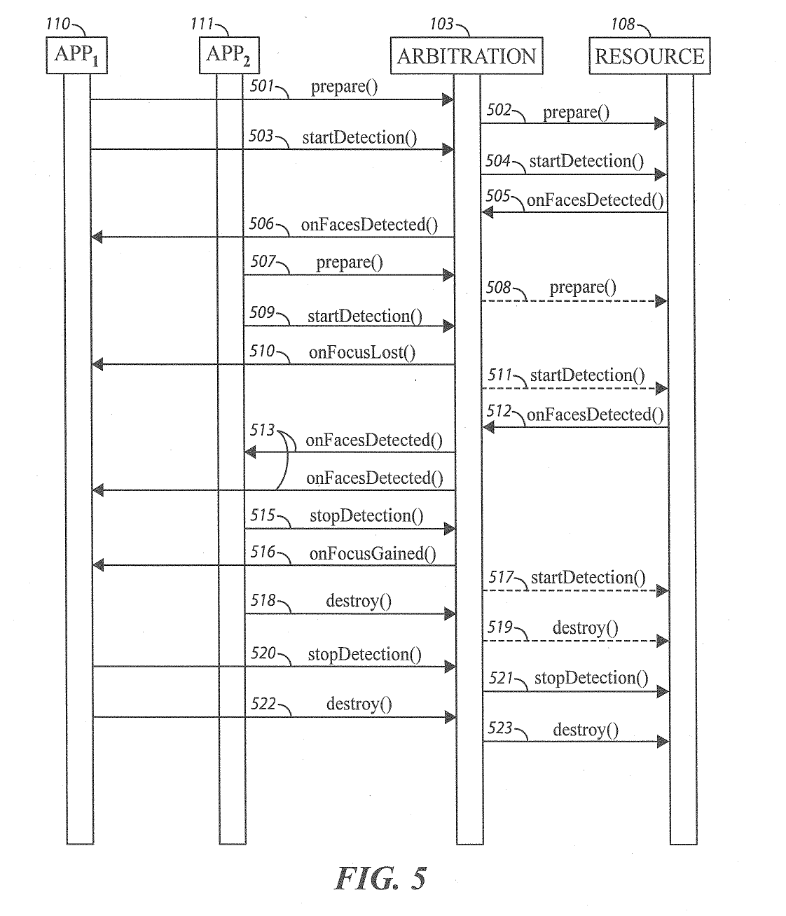

Turning now to FIGS. 4 and 5, a non-limiting contextual example of the operation of various embodiments of the apparatus 100 as depicted in FIGS. 1-3 is provided to aid the reader. It will be appreciated that the following example is merely but one explanatory application of various embodiments, and the discussed example client applications 101, settings, signals, messages, resources 102, function calls, requests, and situations may be readily exchanged for others in keeping with the spirit of this disclosure.

A display 401 such as a television or a monitor is provided. Additionally, a camera 402 and a microphone 403 are provided. The camera 402 and microphone 403 may represent resources 102 or hardware resources 201,202, as depicted in FIGS. 2 and 3. Lastly, a user 404 is depicted making at least one gesture 405. FIG. 5 illustrates communications between two client applications 110, 111, the arbitration module 103, and a resource 108. For purposes of this example, APP₁ 110 of FIG. 5 may correspond to APP₁ 110 of FIG. 2, APP₂ 111 of FIG. 5 to APPᵢ 111 of FIG. 2, arbitration module 103 of FIG. 5 to arbitration module 103 of FIG. 2, and RESOURCE 108 of FIG. 5 to resource 108 of FIG. 2.

More and more, the modern television 401 is becoming not only a multimedia playback device, but a fully integrated part of a home or business. Users 404 may benefit from incorporating such features as handling phone calls, displaying visitors at a door, and displaying and accessing web content. Essentially, a modern television 401 may incorporate many features generally found on a conventional home computer with the possible features being nearly endless. To encourage this trend, the television 401 is configured to run various client applications 101, such as third party client applications, proprietary client applications, or native client applications. The television 401 may comprise an OS (such as Android or Apple iOS) or other mechanism to facilitate operation of the client applications 101. By this, client applications 101 may be developed for the television 401 (or existing client applications 101 may be made to work with the television 401) in much the same manner that client applications 101 are currently being developed for smartphones and tablet computers (such as for Android OS or Apple iOS), thus facilitating the continuous expansion of the abilities and features of the modern television 401.

As a non-exhaustive list of exemplary new features, the television 401 may be configured to detect natural inputs such as voice commands and gestures 405 (as depicted by the user 404 waiving his or her hand) to control certain aspects or behaviors of the television 401. Additionally, the television 401 may be equipped with other features such as face recognition or detection, parental control (by detecting the age of a user 404), sleep detection (by detecting if a user 404 is asleep), or other features. These features are implemented through client applications 101 that utilize the resources 102 of the television 401 (i.e., the camera 402 and the microphone 403 in these examples).

Returning to the non-limiting example of FIGS. 4 and 5, the television 401 may have installed a client application 101 for interacting with social media (e.g., Facebook, Twitter, etc.). To place this in context of the previously described apparatus 100 of FIG. 2, the social media client application may be represented by client application APP₁ 110 (and will be labeled so), which also corresponds to APP₁ 110 of FIG. 5. The social media client application 110 may be configured to utilize face recognition to determine the identity of the user 404 who is present at the television 401. This may be to automatically present the user 404 with social media information in connection with his or her social media profiles, to update the user's 404 profiles or status, or to allow automatic login without a password, to provide some examples. To utilize face recognition, the social media client application 110 (again represented by APP₁ 110) requests the identities of one or more users 404 in front of the television 401 by sending this request to the arbitration module 103 through the API 104. More specifically, the social media client application 110 my send, for example, a prepare( ) call 501 to the arbitration module 103 requesting the identity of the user 404 or listing parameters of the request.

It should be noted that the example calls and callbacks discussed herein and shown in various figures (i.e., “prepare( )”, “onFacesDetected( )”, etc.) are entirely non-limiting examples. One skilled in the art will readily recognize that any name or label may be given to these calls and callbacks, with the examples provided being but individual illustrations of such. Additionally, their functionality may or may not be divided among multiple calls or callbacks, or multiple calls or callbacks discussed herein may be combined into a single calls or callbacks.

The arbitration module 103 may then process the prepare( ) 501 call according to the arbitration rules 105 and can determine that the resource 108 is currently available. Subsequently, the arbitration module 103 may send a prepare( ) 502 request to the resource 108 responsible for face detection, represented in this example by RESOURCE₁ 108 of FIGS. 2 and 5. The face detection resource 108 further comprises an engine 203 responsible for face detection (called an “input engine”), represented in this example by ENGINE₁ 203 which is in communication with the camera 402, represented in this example by HARDWARE RESOURCE₁ 201. By one approach, the engines 203, 204, 205 may be written and/or operated in Linux, but through the use of the API 104 and a possible operating system (e.g., Android) on top of the engines 203, 204, 205, the client applications 101 are able to interact with the resources 102.

Communications between the arbitration module 103 and the resources 102 may or may not mirror the communications between the client applications 101 and the API 104. In this example, the prepare( ) call 502 may be a copy of the prepare( ) call 501 sent to the arbitration module 103, or it may be altered in some form. The alterations may be due to processing on the part of the arbitration module 103, possibly based on the arbitration rules 105, or simply due to translation between incompatible communication protocols. It is appreciated that the mere labeling of the communications 501, 502 “prepare( )” in both instances may convey the purpose of the communication more than the form. Such principles apply to all labeling of the communications described herein.

The resource 108, including engine 203, will configure itself according to the received prepare( ) call 502. Subsequently, in this example, the social media client application 110 may send a startDetection( ) 503 call to the arbitration module 103 through the API 104 directing the resource 108 to start detecting and recognizing the face of the user 404. Because the detection is a processor-intensive function, the client applications 101 can indicate when to start and stop face detection when specifically needed. The resource 108 can maintain current detection settings (according to the prepare( ) call 502) active until further detections are no longer needed (as indicated by a destroy( ) call 519, 523, thus unbinding the resource 108). As before, the arbitration module 103 may process the startDetection( ) call 503 and send a corresponding startDetection( ) call 504 to the resource 108.

Upon receipt of the startDetection( ) call 504, the resource 108 may start detection. More specifically, the face detection engine 203 might receive an image of the scene in front of the television 401, including the user 404, from the camera 402 (i.e., hardware resource 201). The face detection engine 203 in turn can process the image and return at least an identity of the user 404 to the arbitration module 103, represented by the onFacesDetected( ) callback 505. The arbitration module 103 subsequently may determine that at least the social media client application 110 should receive this information and can send a corresponding onFacesDetected( ) callback 506 to the social media client application 110, which in turn can utilize the received recognized user identification as previously described.

In this example, the television 401 may also have installed a client application 101 for browsing media. The media browsing client application 111 may be represented by client application APPᵢ 111 of FIG. 2, which also corresponds to APP₂ 111 of FIG. 5. The media browsing client application 111 may also benefit from knowing the identity of the user 404, so that, for example, it may organize a customized list of favorites for that user 404. Accordingly, the media browsing client application 111 may send a prepare( ) call 507 requesting the identity of the user 404.

Because the client applications 101 may generally be unaware of each other or the availability of resources 102 with respect to other client applications 101, a second request for access to a resource (i.e., the second prepare( ) call 507 in this example) may coincide or conflict with another client application's 101 use of the resource 102. In this example, the media browsing client application 111 may be requesting access to the same information that the social media client application 110 was requesting, e.g., the identity of the user 404. By this, the contents of the prepare( ) calls 501, 507 from each client application 110, 111 may be identical or near identical. In such an instance, the arbitration module 103 may determine to not forward the prepare( ) call 507 to the resource 108 as the resource is already configured to provide the proper response. Additionally, by some embodiments, the resource 108 does not necessarily need to be aware of the individual client applications 101, only its own configuration and requested tasks.

Therefore, the arbitration module 103 may not be required to submit duplicate prepare( ) calls 501, 507 to the resource 108.

In another example, the prepare( ) call 507 from the media browsing client application 111 may request access to different or additional information from that of the prepare( ) call 501 from the social medial client application 110. For example, the second prepare( ) call 507 may request if the user 404 is underage (which may be determined by the image of the user) to determine if parental controls should apply to the user 404 with respect to the media available through the media browser. In this instance, and by at least one embodiment, the arbitration module 103 may be configured to create a new prepare( ) call 508 consisting of the superset of the requested information in the prepare( ) calls 501, 507 from both client applications 110, 111 (i.e., the identity of the user and the underage status of the user), which may then be sent to the resource 108.

By at least one embodiment, the media browsing client application 111 may be unaware that the resource 108 is already currently detecting faces. Therefore, the media browsing client application 111 may send a startDetection( ) call 509, in a similar manner as described above. Again, the arbitration module 103 can then decide based on the arbitration rules 105, and, optionally, a current configuration of the resource 108, if it needs to send the second startDetection( ) call 509 to the resource. The arbitration module 103 may consider that the resource 108 may already be providing the necessary information, either by virtue of identical or similar prepare( ) calls 501, 507 or because the resource 108 has already adjusted its output data according to the optional second prepare( ) call 508 sent to it. In such a case it might not send a startDetection( )call 511 and merely forward all responses to both client applications 110, 111 (as discussed below). Alternatively, the arbitration module 103 will send a startDetection( ) call 511 to effectuate detection according to new information requested in the second prepare( ) call 507.

In some instances, and by some approaches, to properly effectuate the requested new actions by the resource 108, the arbitration module 103 may be required to stop the current processes of the resource 108 using, for example, a stopDetection( ) call in conjunction with either the prepare( ) 508 or the startDetection( ) calls 511 to reset the resource 108 to the new requested configuration. Alternatively, the resource 108 may be capable of altering its tasks on-the-fly without being reset.

By some approaches, the second client application 111 (i.e., the media browsing client application 111) may be located in the native layer 207. In this instance, a native thin layer interface 301 can be utilized, as depicted in FIG. 3, and the arbitration module 103 and the native layer arbitration module 302 can communicate to achieve a common arbitration scheme. As such, the arbitration module 103 of FIG. 5 may represent the joint efforts of both the arbitration module 103 and the native layer arbitration module 302.

Upon receipt of the second startDetection( ) call 509 from the media browsing client application 111, the arbitration module 103 can determine (or arbitrate) which (either or both) of the client applications 110, 111 is to have access to the resource 108. Traditionally, arbitration would be limited to notifying the second requesting client application 111 of the unavailability of the resource 108, or alternatively, ending access by the first client application 110 to allow the second requesting client application 111 access to the resource 108. For example, if a user 404 is using a first video chat client application, e.g., Skype, that is utilizing the camera resource 402 and the user 404 subsequently initiates a second video chat client application, e.g., MSN Messenger video chat, the first client application, Skype, will loose access to the camera resource 402 in favor of MSN Messenger video chat. Alternatively, the MSN Messenger video chat client application will not begin using the camera 402 until Skype has released the camera resources 402. In either of these situations, traditional arbitration results in only one client application 101 accessing the resource 102 at a time. However, according to at least some embodiment disclosed herein, it is possible for both the first and the second client applications 110, 111 to access the camera resources 402.

In this example, the arbitration module 103 determines that both client applications 110, 111 will be granted access to the resource 108, but further determines that the social media client application 110 will be notified of a loss of focus through an onFocusLost( ) callback 510. Here, the media browsing client application 111 is the “active” client application 101 being utilized by the user 404 (possibly by virtue of it being more recently initiated). As such, it is the “focus” of the user 404, and the social media client application 110 may be in the background. By one approach, and as is familiar to one skilled in the art or familiar with computer or mobile applications, this may comprise the active client application being displayed on the screen to the exclusion of the non-active client application, or possibly highlighted as the active open client application, which generally is capable of direct interaction with the user 404.

The social media client application 110 may receive the onFocusLost( ) callback 510 and is made aware that it may or may not receive further information from the resource 108. Additionally, the social media client application 110 can be placed into an onFocusLost( ) state which may affect how it reacts to further information received from the resource 108 or other resources 102.

Upon detection, the resource 108 may send an onFacesDetected( ) callback 512 to the arbitration module 103. The arbitration unit can then determine two or more client applications of the plurality of client applications 101 to grant simultaneous access to the message 512 (in this example, both the social media client application 110 and media browsing client applications 111). The arbitration module 103 can make this determination based on the plurality of arbitration rules 105. By at least one approach, the two or more client applications determined by the arbitration module 103 comprises a set less than the whole of the plurality of the client applications 101. Though the arbitration module 103 is in no way limited to sending the information to client applications 101 specifically requesting that information, here, because both the social media 110 and media browsing client applications 111 requested the data, the arbitration module 103 may communicate an onFacesDetected( ) callback 513 to both simultaneously, or nearly simultaneously.

Assuming the media browsing client application 111 requested further information regarding the underage status of the user 404, as described in this example above, the onFacesDetected( ) callback 513 might contain that additional requested information. Resultantly, although only the media browsing client application 111 requested this extra information, the social media client application 110 may also receive it. The social media client application 110, however, can simply disregard the extra information contained in the onFacesDetected( ) callback 513 and consume and utilize only the information that it requested or requires (i.e., the identity of the user in this example).

At some point after receipt of the requested data captured in the onFacesDetected( ) callback 513, one of the client applications 111 may send a stopDetection( ) call 515, thereby instructing the resource 108 to cease detection and processing of images, which can be a processing-intensive function. In this example, the media browsing client application 111 sends the stopDetection( ) call 515 (possibly because the user 404 placed the media browser into the background), at which point the arbitration module 103 may send a onFocusGained( ) callback 516 to the social media client application 110, possibly indicating that it is the active client application. Additionally, the media browsing client application 111 may send a destroy( ) call 518 (possibly due to the user 404 closing the media browser). Optionally, and similar to as described above, the arbitration module 103 may need to send an additional startDetection( ) call 517 to the resource 108 to place the resource 108 back into a configuration that the social media client application 110 originally requested with its previous prepare( ) 501 and startDetection( ) 503 calls. The arbitration module 103 may additionally send a stopDetection( ) to reset the resource 108, or possibly even a destroy( ) and/or prepare( ) (not shown) to reconfigure the resource 108. In response to receiving the destroy( ) call 518 from the media browsing client application 111, the arbitration module 103 may send a same or similar destroy( ) 519 call to the resource 108 thereby releasing the resource 108 from maintaining the configuration requested by the media browsing client application 111 via its prepare( ) call 507, while possibly maintaining the configuration as requested by the social media client application 110 in its prepare( ) call 501.

Finally, in much the same manner as described directly above, the first client application 110 (i.e., the social media client application 110) may no longer require the services of the resource 108 and may send a stopDetection( ) 520 and/or a destroy( )call 522. The arbitration module 103 may communicate these calls 521, 523 to the resource 108, at which time the resource 108 is unbound.

In the above described non-limiting example, it is appreciated that this is but one example of how the apparatus 100, including the arbitration module 103, may arbitrate access to the resources 102. Many different orders of events may occur involving a variety of differing client applications 101, settings, signals, messages, resources 102, function calls, requests, and situations. The use of the example “social media client application” and “media browsing client application” are in no way limiting, and are mere examples of two possible client applications (i.e., APP₁110 of FIG. 5 and AP₁ 110 of FIG. 2, APP₂ 111 of FIG. 5 and APPᵢ 111 of FIG. 2). Often, more than two client applications 101 may be involved in such arbitration utilizing any number of different function calls and communication methods.

As another brief non-limiting example, the first client application APP₁ 110 may comprise a media player client application 110 and APPᵢ 111 or APP₂ 111 may comprise a phone client application 111. A gesture recognition resource may be represented by resource 206, further comprising a gesture recognition engine 204 and the camera hardware resource 201. In this example, the user 404 may be watching a video through the media player client application 110 on the television 401, at which time a phone call may be received. The user 404 may make a gesture 405, as generically depicted in FIG. 4, representing a command to both pick up the phone to the phone client application 111 and to pause the video to the media player client application 110. Under traditional arbitration schemes, only one client application 101 would receive the gesture 405, resulting possibly in a need for the user 404 to stop the media player client application 110 and then separately tell the phone client application 111 to pick up the call. However, by at least some of the embodiments described herein, the arbitration module 103 can determine to send the one recognized gesture 405 to both the media player client application 110 and the phone client application 111 simultaneously, whereupon both can react as described.

In some embodiments, the arbitration module 103 may be receptive to events or commands from the system or framework 210 optionally thought the system interface module 209 or through the API 104. For example, if the system 210 will answer a phone call, the system 210 might fire off a phone call intent, to which either the API 104 or the system interface module 209 is receptive to, and thus, the arbitration module 103 is receptive to. Upon receipt of the example phone call intent, the arbitration module 103 may act to grant the system 210 access to the microphone 403, speaker, camera 402, etc., of the television 401 to enable the call. Further, the arbitration module 103 may react by stopping or halting the use of certain resources 102 by certain client applications 101, i.e., automatically pause a media player client application 110 when the phone call begins. Upon completion of the phone call event, the arbitration module 103 may resume the client applications 101 and resources 102. Additionally, and by some approaches, the arbitration module 103 may alter or change the use of the arbitration rules 105 or the arbitration rules 105 themselves according to the received system event. By this, the arbitration module 103 may be receptive to events, even if they do not concern the arbitration module 103 directly, and is capable of reacting to them. Again, it is appreciated that any number of system events may be received and any number of resulting behaviors may ensue, the above phone call event being but one example.

So configured, and as described in the various non-limiting examples above, various embodiments of the apparatus 100, possibly including the arbitration module 103 and the API 104, can arbitrate client application 101 access to at least one resource 102. In doing so, data and resources 102 are exposed to multiple client applications 101 and simultaneous multiple use of resources 102 by separate multiple client applications 101 can be achieved. Previously, no need existed to grant multiple client applications 101 access to data or resources 102. For example, when Skype is using a camera resource 402, MSN Messenger video chat will not need the camera 402; or when a phone call is in process, a media player does not need the speakers. Now, due to the birth of new functionality in client applications 101, users 404 can benefit from simultaneous multiple use of resources 102 by different client applications 101 (as described in examples presented above).

While providing the multiple exposure and multiple use features, the apparatus 100 determines which multiple client applications 101 are to be granted access to data or resources 102, which, in some embodiments, may entail denying (or simply not offering) access to data or resources 102 to some client applications 101. By this, various embodiments provide functionality beyond a simple broadcast of data or messages—they provide selective determination of recipient client applications 101. Accordingly, many advantages can be realized. First, by avoiding a full broadcast of data or messages, certain embodiments save processing power consumed by client applications 101 because not every client application 101 will process an incoming message. Only client applications 101 that the arbitration module 103 has determined require the data or message, or are allowed to access it, receive the data or message.

Additionally, some embodiments provide for avoidance of conflicts or misunderstandings, possibly between various client applications 101 utilizing incompatible vocabularies. For example, a speech detection engine 205 that utilizes the microphone 403 is loaded with a vocabulary. In this example, the vocabulary is for use in conjunction with a game, and may include commands such as “stop,” or “forward.” The arbitration module 103 may be aware that this vocabulary is loaded and upon receiving a message from the speech detection engine 205 of a “forward” speech command, the arbitration module 103 can determine that the one or more client applications 101 associated with the game are to receive it, but not a media player client application, which utilizes a different vocabulary and might misinterpret the command as an instruction to fast-forward an item of media. Also, as a corollary, if the media player client application had been active when the conflicting vocabulary was loaded into the speech detection engine, the media player may receive a onFocusLost( ) command indicating it would no longer be receiving data in this example.

Also, some embodiments provide for added security elements between client applications 101. For example, if a first client application 101 required a password for entry (possibly through a speech or gesture detection engine), but did not want other client applications 101 to learn this password, the first client application 101 may indicate to the arbitration module 103 that the next received gestures or speech are a password and are to be delivered only to the first client application 101. Thus, security may be maintained between various client applications 101.

Additional uses and benefits of various embodiments may include sending and/or receiving intents from the system 210, sending broadcasts, checking permissions of client applications 101, ensuring certain conditions such that the client applications 101 make the function calls only from a main user interface (UI) thread, recording and/or storing the process identifications (processID) of client applications 101, and providing process separation thereby providing safety against client application 101 crashes.

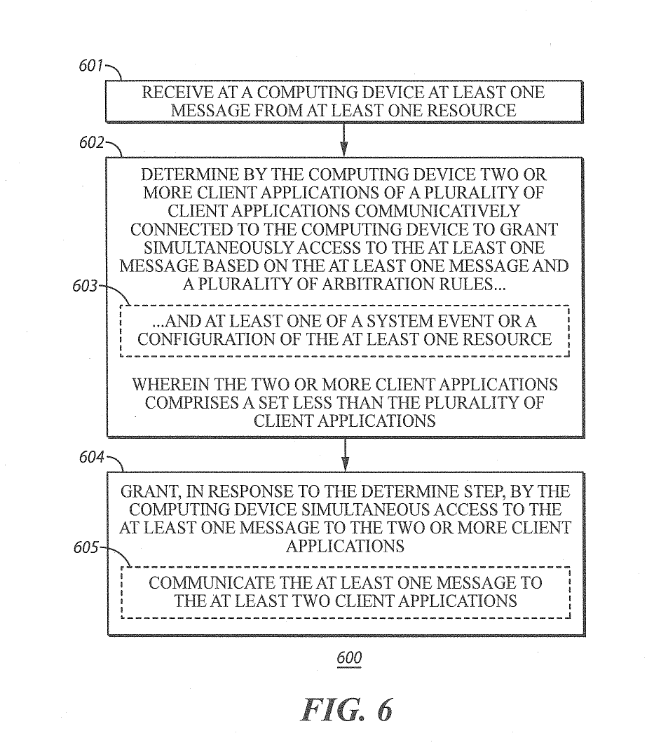

Referring now to FIG. 6, a flow diagram 600 illustrating a method of arbitrating client application 101 access to at least one resource 102 in accordance with various embodiments is shown. Although many of the steps described in this and the ensuing flow diagram figures have been described in the non-limiting contextual examples provided above, these flow diagrams and corresponding descriptions are provided to further aid the reader with a more general description. At step 601, a computing device receives at least one message from at least one resource 108. This may comprise a function callback, response, or other piece of data. The computing device may comprise one or more processing devices (including processors, multi-core processors, microprocessors, etc), at least one memory or storage device, and various inputs and outputs. Further, the computing device may comprise the apparatus 100, either in whole or part. The computing device may also comprise the various client applications 101 and resources 102 or engines 203, 204, 205. It should be appreciated that the phrase “receiving at” is not limited to receiving from an external source. At step 602, the computing device determines two or more client applications 110, 111 of a plurality of client applications 101 communicatively connected to the computing device to grant simultaneous access to the at least one message based on the at least one message and a plurality of arbitration rules 105, and optionally, by step 603, at least one of a system event or a configuration of the at least one resource 108, wherein the two or more client applications 110, 111 comprises a set less than the plurality of client applications 101. Lastly, at step 604, the computing device may grant, in response to the determine step 602, simultaneous access to the at least one message to the two or more client applications 110, 111. Optionally, and by step 605, this may entail the computing device communicating the at least one message to the at least two client applications 110, 111. Communicating the message does not necessarily comprise communicating the entire message in its original form. Communicating the message may simply comprise communicating a portion of the message or even simply the intent of the message. It should be appreciated that differing communication schemes and protocols may be utilized in communications between various parties, while the intent of a communicated message may be preserved.

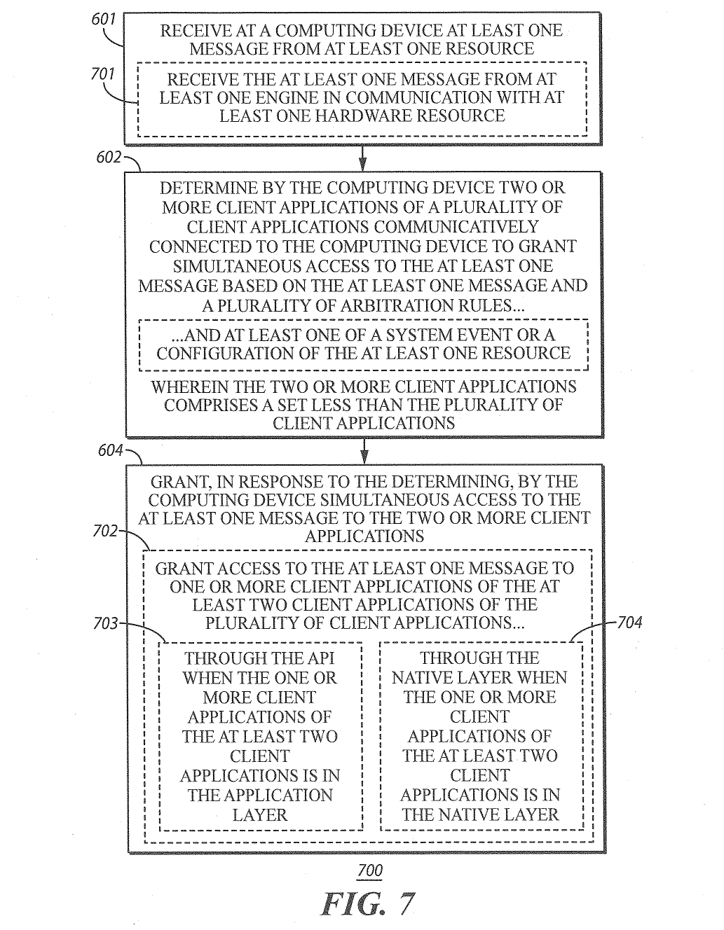

Referring now to FIG. 7, a flow diagram 700 depicting another embodiment of the method illustrated in FIG. 6 is shown. As described above, at step 601 the computing device receives the at least one message from the at least one resource 108. Optionally, as shown in step 701, this may comprise receiving the at least one message from at least one engine 203, 204, 205 in communication with at least one hardware resource 201, 202. Step 602 is as previously described. Step 604 is as previously described, but may further comprise one or more of the steps 702, 703, and 704 of granting access to the at least one message to one or more client applications of the at least two client applications 110, 111 of the plurality of client applications 101 through the API 104 when the one or more client applications of the at least two client applications 110, 111 is in the application layer 106, and through the native layer when the one or more client applications of the at least two client applications is in the native layer 207.

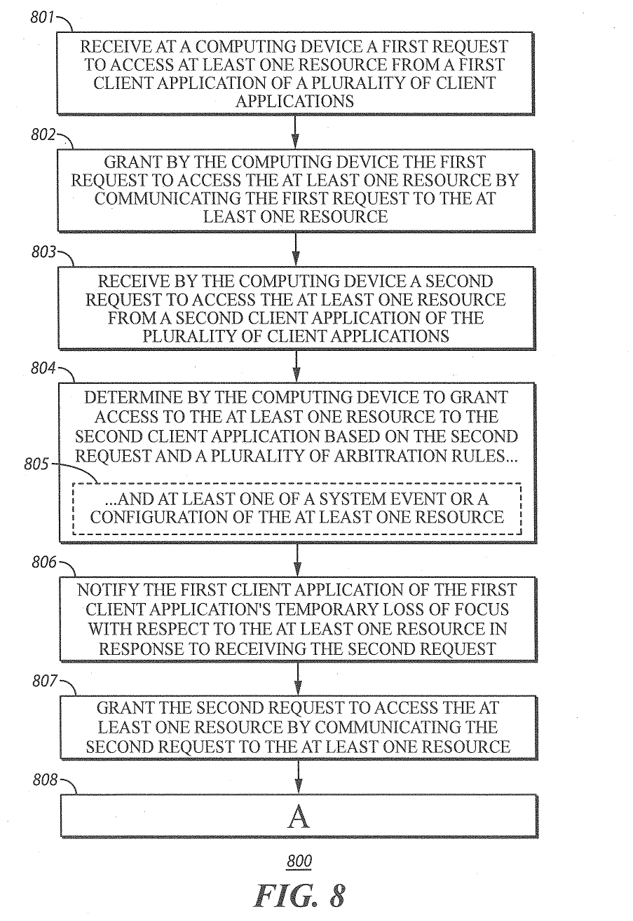

Referring now to FIG. 8, a flow diagram 800 illustrating a method of arbitrating client application 101 requests for access to at least one resource 102 in accordance with various embodiments is shown. At step 801, a computing device receives a first request to access at least one resource 108 from a first client application 110 of a plurality of client applications 101. At step 802, the computing device grants the first request to access the at least one resource 108 by communicating the first request to the at least one resource 108. It should be appreciated that communicating a request does not necessarily comprise communicating the entire request in its original form. Communicating the request may simply comprise communicating a portion of the request or even simply the intent of the request. Further, differing communication schemes and protocols may be utilized in communications between various parties, while the intent of a communicated request may be preserved.

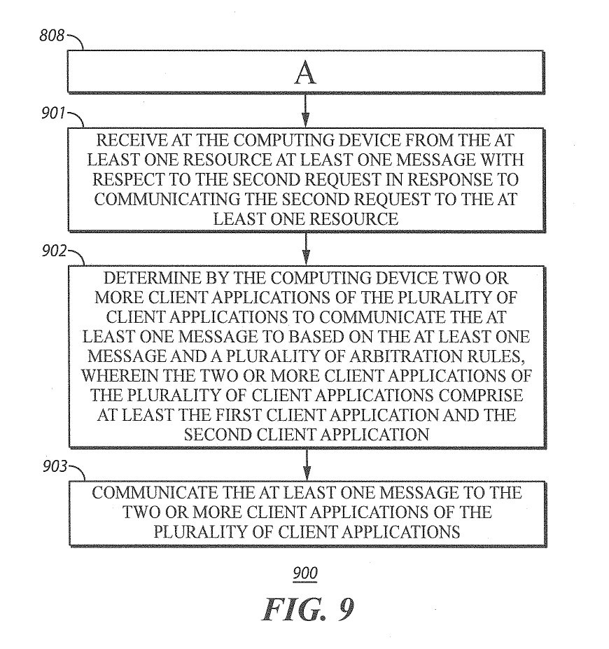

Continuing to step 803, the computing device receives a second request to access the at least one resource from a second client application 111 of the plurality of client applications 101. At step 804, the computing device determines to grant access to the at least one resource 108 to the second client application 111 based on the second request and a plurality of arbitration rules 105 and, optionally, per step 805, at least one of a system event or a configuration of the at least one resource 108. At step 806, the computing device notifies the first client application 110 of the first client application's temporary loss of focus with respect to the at least one resource 108 in response to receiving the second request. For example, the computing device may deliver an onFocusLost( ) callback 510 or similar. At step 807, the computing device grants the second request to access the at least one resource 108 by communicating the second request to the at least one resource 108. Box “A” 808 represents a theoretical placeholder from which other embodiments described below in FIGS. 9 through 11 may in corporate further steps. It is understood that the steps described below do not necessarily correlate to a specified order, and steps described in FIGS. 9 through 11 may come before or after steps described in FIG. 8.

Referring next to FIG. 9, a flow diagram 900 depicting further steps from those illustrated in FIG. 8 in accordance with one embodiment is shown. In addition to steps outlined in FIG. 8, as indicated by box “A” 808, at step 901, the computing device receives from the at least one resource 108 at least one message with respect to the second request in response to communicating the second request to the at least one resource 108. At step 902, the computing device determines two or more client applications 110, 111 of the plurality of client applications 101 to communicate the at least one message to based on the at least one message and a plurality of arbitration rules 105, wherein the two or more client applications 110, 111 of the plurality of client applications 101 comprises at least the first client application 110 and the second client application 111. At step 903, the computing device communicates the at least one message to the two or more client applications 110, 111 of the plurality of client applications 101.

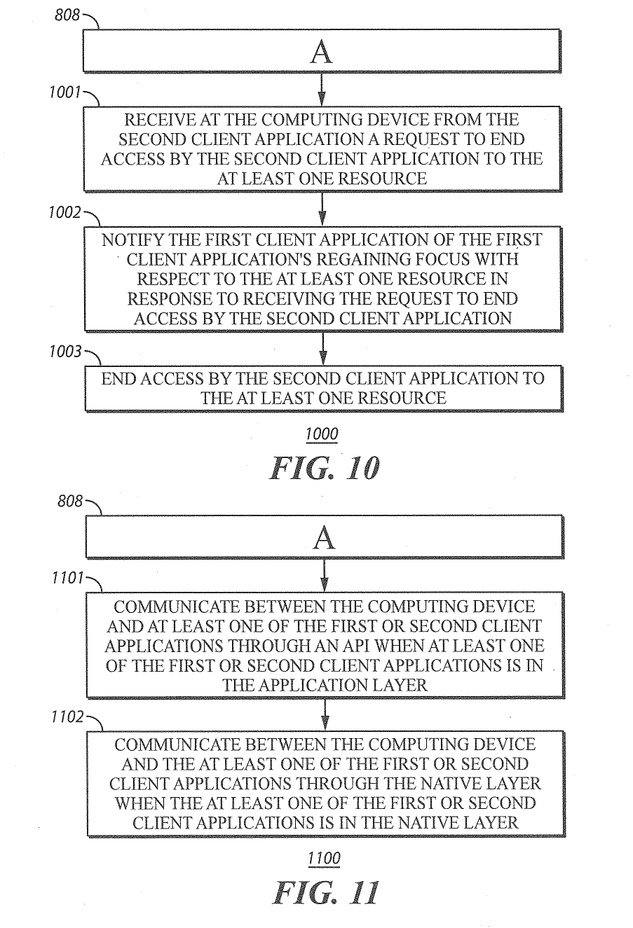

Referring next to FIG. 10, a flow diagram 1000 depicting further steps from those illustrated in FIG. 8 in accordance with another embodiment is shown. In addition to steps outlined in FIG. 8, as indicated by box “A” 808, at step 1001, the computing device receives from the second client application 111 a request to end access by the second client application 111 to the at least one resource 108. For example, this could comprise a stopDetection( ) 515 or destroy( ) call 518 or similar from the second client application 111. At step 1002, the computing device notifies the first client application 110 of the first client application's 110 regaining focus with respect to the at least one resource 108 in response to receiving the request to end access by the second client application 111. For example, this could comprise a onFocusGained( ) callback 516 or similar. Lastly, at step 1003, the computing device ends access by the second client application 111 to the at least one resource 108.

Referring lastly to FIG. 11, a flow diagram 1100 depicting further steps from those illustrated in FIG. 8 in accordance with another embodiment is shown. In addition to steps outlined in FIG. 8, as indicated by box “A” 808, at step 1101, the computing device communicates between the computing device and at least one of the first or second client applications 110, 111 through the API 104 when the at least one of the first or second client applications 110, 111 is in the application layer 106 and, at step 1102, communicates between the computing device and the at least one of the first or second client applications 110, 111 through the native layer 207 when the at least one of the first or second client applications is in the native layer 207.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors or processing devices. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of arbitrating client application access to at least one resource comprising:
receiving at a computing device at least one message from at least one resource;
determining by the computing device two or more client applications of a plurality of client applications communicatively connected to the computing device to grant simultaneous access to the at least one message based on the at least one message and a plurality of arbitration rules, wherein the two or more client applications comprises a set less than the plurality of client applications; and
granting, in response to the determining, by the computing device simultaneous access to the at least one message to the two or more client applications.

2. The method of claim 1 wherein granting simultaneous access to the at least one message to the two or more client applications further comprises communicating the at least one message to the at least two client applications.

3. The method of claim 1 further comprising determining the two or more client applications of the plurality of client applications to grant simultaneous access to the at least one message based on the at least one message, a plurality of arbitration rules, and at least one of a system event or a configuration of the at least one resource.

4. The method of claim 1 wherein the at least one message comprises at least one of a call or a callback.

5. The method of claim 1 wherein the computing device comprises an application programming interface (API).

6. The method of claim 5 wherein the plurality of client applications comprises at least one client application in an application layer and at least one application in a native layer, and
wherein the granting by the computing device simultaneous access to the at least one message to the two or more client applications further comprises:
granting by the computing device access to the at least one message to one or more client applications of the at least two client applications through the API when the one or more client applications of the at least two client applications is in the application layer and through the native layer when the one or more client applications of the at least two client applications is in the native layer.

7. The method of claim 1 wherein receiving at the computing device the at least one message from the at least one resource further comprises receiving the at least one message from at least one engine in communication with at least one hardware resource.

8. A method of arbitrating client application requests for access to at least one resource comprising:
receiving at a computing device a first request to access at least one resource from a first client application of a plurality of client applications;
granting by the computing device the first request to access the at least one resource by communicating the first request to the at least one resource;
receiving by the computing device a second request to access the at least one resource from a second client application of the plurality of client applications;
determining by the computing device to grant access to the at least one resource to the second client application based on the second request and a plurality of arbitration rules;
notifying the first client application of the first client application's temporary loss of focus with respect to the at least one resource in response to receiving the second request; and
granting the second request to access the at least one resource by communicating the second request to the at least one resource.

9. The method of claim 8 further comprising determining by the computing device to grant access to the at least one resource to the second client application based on the second request, a plurality of arbitration rules, and at least one of a system event or a configuration of the at least one resource;

10. The method of claim 8 further comprising:
receiving at the computing device from the at least one resource at least one message with respect to the second request in response to communicating the second request to the at least one resource;
determining by the computing device two or more client applications of the plurality of client applications to communicate the at least one message to based on the at least one message and a plurality of arbitration rules, wherein the two or more client applications of the plurality of client applications comprises at least the first client application and the second client application; and
communicating the at least one message to the two or more client applications of the plurality of client applications.

11. The method of claim 8 wherein the at least one resource comprises at least one engine in communication with at least one hardware resource.

12. The method of claim 8 further comprising:
receiving at the computing device from the second client application a request to end access by the second client application to the at least one resource;
notifying the first client application of the first client application's regaining focus with respect to the at least one resource in response to receiving the request to end access by the second client application; and
ending access by the second client application to the at least one resource.

13. The method of claim 8 wherein the computing device comprises an application programming interface (API).

14. The method of claim 13 wherein the plurality of client applications comprises at least one client application in an application layer and at least one application in a native layer, and
wherein communications between the computing device and at least one of the first or second client applications are through the API when the at least one of the first or second client applications is in the application layer and through the native layer when the at least one of the first or second client applications is in the native layer.

15. The method of claim 8 wherein communicating the first request and the second request to the at least one resource further comprises communicating the first request and the second request to at least one engine in communication with at least one hardware resource.

16. An apparatus for arbitrating client application access to at least one resource comprising:
an Application Programming Interface (API) module configured to communicate with a plurality of client applications; and
an arbitration module communicatively connected to the API module, wherein the arbitration module is configured to:
receive at least one message from at least one resource;
determine two or more client applications of the plurality of client applications to communicate the at least one message to based on the at least one message and a plurality of arbitration rules;
communicate the at least one message to the two or more client applications, wherein the arbitration module is further configured to communicate the at least one message to at least one client application of the two or more client applications of the plurality of client applications through the API module; and
deny access to the at least one message to at least one other client application of the plurality of client applications.

17. The apparatus of claims 16 wherein the arbitration module is further configured to:
receive a first request for access to the at least one resource from a first client application of the two or more client applications through the API module;
grant the first request to access the at least one resource by communicating the first request to the at least one resource;
receive a second request for access to the at least one resource from a second client application of the at least two client applications through the API module;
determine to grant access to the at least one resource to the second client application based on the second request and a plurality of arbitration rules;
notify the first client application of a temporary loss of focus with respect to the at least one resource through the API module in response to receiving the second request;
grant the second request to access the at least one resource by communicating the second request to the at least one resource;

18. The apparatus of claims 17 wherein the arbitration module is further configured to:
receive from the second client application of the at least two client applications a request to end access by the second client application to the at least one resource;
notify the first client application of the at least two client applications of a regaining of focus with respect to the at least one resource in response to receiving the request to end access by the second client application; and
end access by the second client application to the at least one resource.

19. The apparatus of claim 16 further comprising:
a system interface module communicatively connected to the arbitration module and configured to receive at least one system event; and
wherein the arbitration module is further configured to:
determine two or more client applications of the plurality of client applications to grant simultaneous access to the at least one message based on the at least one message, the plurality of arbitration rules, and at least one of a system event or a configuration of the at least one resource.

20. The apparatus of claim 16 further comprising:
a native interface module communicatively connected to the arbitration module and configured to communicate with at least one client application located in a native layer; and
wherein the arbitration module is further configured to communicate the at least one message to at least one other client applications of the two or more client applications of the plurality of client applications through the native interface module.
